(19) United States
(12) Patent Application Publication
(10) Pub. No.: US 2013/0339241 A1
(43) Pub. Date: Dec. 19, 2013

(54) TRANSACTIONAL PERMISSIONS

(71) Applicants: Alexander Knight, Seattle, WA (US); Patrick John Ennis, Fall City, WA (US); Vlad Grigore Dabija, Mountain View, CA (US); Timothy Martin Londergan, Seattle, WA (US); David Walter Ash, Bellevue, WA (US); Dominic Dan Suciu, Edmonds, WA (US); Raghuram Madabushi, Seattle, WA (US)

(72) Inventors: Alexander Knight, Seattle, WA (US); Patrick John Ennis, Fall City, WA (US); Vlad Grigore Dabija, Mountain View, CA (US); Timothy Martin Londergan, Seattle, WA (US); David Walter Ash, Bellevue, WA (US); Dominic Dan Suciu, Edmonds, WA (US); Raghuram Madabushi, Seattle, WA (US)

(73) Assignee: EMPIRE TECHNOLOGY DEVELOPMENT LLC, Wilmington, DE (US)

(21) Appl. No.: 13/810,822

(22) PCT Filed: Jun. 13, 2012
(86) PCT No.: PCT/US12/42215

§ 371 Date: Jan. 17, 2013

(51) Int. Cl. G06Q 20/40

(52) U.S. Cl. CPC G06Q 20/405
USPC 705/44

(57) ABSTRACT

In one example a computer-readable medium storing computer-executable components that comprise, at least, a guardian component configured to receive, from an authoritative entity, conditions upon which a potential transaction for a deferring entity may be authorized; and a transactional component configured to receive, from a transacting entity, a request for authorization for an actual transaction with the deferring entity, and to transmit, to the transacting entity, a determination as to whether the request for authorization for the actual transaction is acceptable in view of the stored conditions.

### TECHNICAL FIELD

The embodiments described herein pertain generally to implementing one or more customized safeguards against unauthorized transactions that may be executed in real-time.

### BACKGROUND

Online commerce, smart card, and smart-phone technologies, singularly and in combination, have created a commercial environment that is ripe for exploitation by unauthorized parties. Examples of current solutions include monitoring by a service provider, e.g., credit card company, for transactions that may exceed a pre-allotted credit limit.

### SUMMARY

In one example embodiment, a computer-readable medium stores computer-executable components that comprise, at least, a guardian component configured to receive, from an authorizing entity, conditions upon which a potential transaction for a deferring entity may be authorized; and a transactional component configured to receive, from a transacting entity, a request for authorization for an actual transaction with the deferring entity, and to transmit, to the transacting entity, a determination as to whether the request for authorization for the actual transaction is acceptable in view of the stored conditions.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example system configuration in which transactional permissions may be implemented, arranged in accordance with at least some embodiments described herein;

FIG. 2 shows an example configuration of a service provider platform by which at least portions of transactional permissions may be implemented, arranged in accordance with at least some embodiments described herein;

FIG. 3 shows an example configuration of a client application by which at least portions of transactional permissions may be implemented, arranged in accordance with at least some embodiments described herein;

FIG. 4 shows an example configuration of a processing flow of operations for transactional permissions implemented by a client device application, in accordance with at least some embodiments described herein;

FIG. 5 shows an example processing flow of operations for transactional permissions implemented by a service provider platform, in accordance with at least some embodiments described herein; and

FIG. 6 shows a block diagram illustrating an example computing device by which various example solutions described herein may be implemented, arranged in accordance with at least some embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

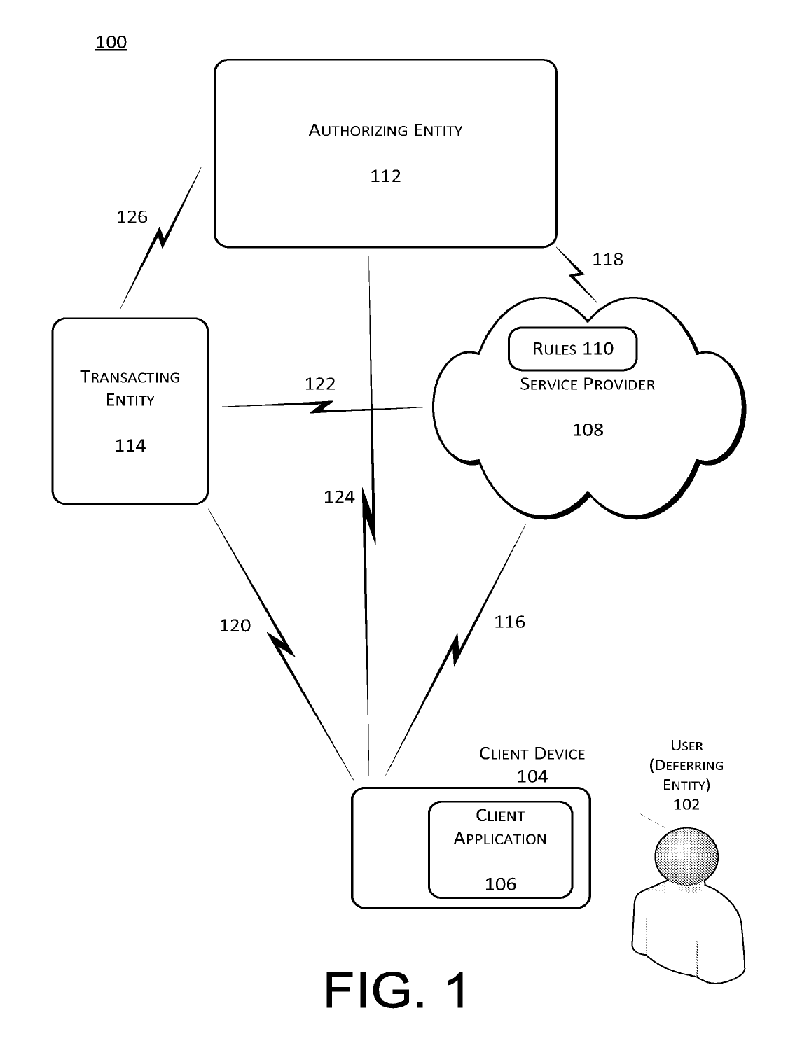

FIG. 1 shows an example system configuration 100 in which transactional permissions may be implemented, arranged in accordance with at least some embodiments described herein. As depicted, configuration 100 includes, at least, a client device 104 with an instance of a client application 106 hosted thereon, a service provider platform 108 that stores rules 110 thereon, an authorizing entity 112, and a transacting entity 114. A user 102, who may alternately be referred to as a deferring entity, may be regarded as a person or entity that exercises ownership or control of client device 104. Non-limiting examples of such an entity as user 102 may include

For example, user 102 may be a person who desires to complete a transaction with transacting entity 114. Non-limiting examples of user 102 as an entity may include an organization (e.g., corporation, university, charity, etc.) on whom transactional limitations may be placed (e.g., budgetary restrictions), and on whose behalf a representative may engage in a transaction, as depicted herein. Such examples are not intended to be limiting, and therefore should not be interpreted to be so.

As described herein, “transaction” may refer to any commercial transaction for which a facet thereof may be subject to authorization by authorizing entity 112. Non-limiting examples of such transactions subject to authorization may include credit or debit card transactions, transactions by gift or value cards, phone calls from a mobile phone or a landline, pay-per-view offerings on television or the internet, internet browsing, etc. Further, classes or classifications of a “transaction” subject to authorization, as referenced throughout the present description include, as non-limiting examples only: payment methods; currency amounts; date and/or time of transaction; location of transaction including geography, store location, website, etc.; subject matter of transaction; etc.; time limits, e.g., for telephone calls or internet browsing; etc.

Client device 104 may refer to a processor-based electronic device on which an instance of client application 106 may be hosted to implement at least portions of transactional permissions. Further, client device 104 may be configured to transmit and receive data over a radio link to service provider 108 by further connecting to a mobile communications network provided by a wireless service provider (not shown). Client device 104 may be implemented as a mobile (or portable) electronic device such as a mobile phone, cell phone, smartphone, personal data assistant (PDA), a personal media player device, an application specific device, or a hybrid device that includes any of the above functions. Client device 104 may also be implemented as a personal computer including tablet, laptop computer, and non-laptop computer configurations, which may be connected to the aforementioned mobile communications network or, alternatively, to a wired network.

The aforementioned wireless service provider for implementing communications for client device 104 may also be known as a mobile network carrier, wireless carrier, or even cellular company. Regardless of the alternate reference, the wireless service provider may provide services for mobile communications subscribers. Client device 104 may be configured to communicate with any of service provider 108, authorizing entity 112, and/or transacting entity 114, all of whom may similarly communicate with each other. Further, client device 104 may be configured to communicate with authorizing entity 112 and/or transacting entity 114 directly in a peer-to-peer networking environment.

Client application 106 may refer to a program implemented by hardware, software, firmware, or any combination thereof that may be utilized to limit the transactional capabilities of client device 104 without direct or indirect authorization from authorizing entity 112. Client application 106 may be included in or otherwise integrated with transactional software (not shown) in order to implement the deferring role of transactional permissions. That is, client application hosted on client device 104 may enable client device 104 to engage with transacting entity 114 in transactions that are subject to authorization. Client application 106 may facilitate user interaction with at least service provider 108, transacting entity 114, and/or authorizing entity 112. Further, at least some embodiments of transactional permissions may contemplate client application 106 representing a web browser that is configured to facilitate user interaction with at least service provider 108, transacting entity 114, and/or authorizing entity 112. Further still, client application 106, or a modified version thereof, may be hosted on authorizing entity 112, as well, in order to implement the authorizing role of transactional permissions.

Service provider 108 may be regarded as a cloud-based service and storage platform owned and/or operated by a third-party service provider. Service provider 108 may include a framework of hardware, software, firmware, or any combination thereof, through which or to which digital data and information may be stored, passed, or shared with regard to a transaction for which at least one subscriber to the hosted service, including client device 104, is a party. More particularly, cloud-based platform 108 may be implemented as a web-based storage and sharing service to which client device 104, authorizing entity 112, and/or transacting entity 114 register prior to use. Such registration may include authorizing entity 112 submitting rules 110 for storage by service provider 108.

Rules 110 may refer to one or more authorization settings that are communicatively received at service provider 108 from authorization entity 112. Rules 110 may include logic implemented by hardware, software, firmware, or any combination thereof, to appropriately enable or disable a transaction involving client device 104, which may or may not be in the possession of or under the control of user 102. Thus, rules 110 may include a “white list,” “black list,” and/or “gray list” of rules and conditions under which transactions and classes of transactions may, respectively, be authorized, be denied, or be subject to further real-time authorization due to peculiar circumstances. Further, at least one alternative embodiment of rules 110 may include a one-time authorization in the form of, e.g., a PIN , that would facilitate a singular “pre-approval” or “blind” authorization for a transaction involving client device 104. The registration of rules 110 by service provider 118 may be performed in coordination with an instance of client application 106 hosted on a device corresponding to authorizing entity 112.

Authorizing entity 112 may refer to a processor-based electronic device on which another instance of client application 106, or modified version thereof, may be hosted to implement at least portions of transactional permissions. Further, authorizing entity 112 may be configured to transmit and receive data over a radio link to service provider 108 by further connecting to a mobile communications network provided by a wireless service provider (not shown). Authorizing entity 112 may be implemented as a mobile (or portable) electronic device such as a mobile phone, cell phone, smartphone, personal data assistant (PDA), a personal media player device, an application specific device, or a hybrid device that includes any of the above functions. Authorizing entity 112 may also be implemented as a personal computer including tablet, laptop computer, and non-laptop computer configurations, which may be connected to the aforementioned mobile communications network or, alternatively, to a wired network.

More particularly, authorizing entity 112, in coordination with service provider 108, may submit or configure rules 110 by which transactions involving client device 104 may by authorized, not authorized, or for which real-time authorization is to be requested by authorizing entity 112. Further still, in a peer-to-peer networking environment, authorizing entity 112 may transmit rules to client device 104 directly for utilization by client application 106.

Transacting entity 114 may refer to a processor-based electronic device configured to transmit and receive data and/or information over a radio link to client device 104 and/or service provider 108 by further connecting to a mobile communications network provided by a wireless service provider (not shown). Similar to client device 104 and authorizing entity 112, transacting entity 114 may be implemented as a mobile (or portable) electronic device such as a mobile phone, cell phone, smartphone, personal data assistant (PDA), a personal media player device, an application specific device, or a hybrid device that includes any of the above functions. Further, transacting entity may also be implemented as a scanner; a cash register; a personal computer including tablet, laptop computer and non-laptop computer configurations; or some other device capable of conducting one or more commercial transactions as referenced herein; any of which may be connected to the aforementioned mobile communications network or, alternatively, to a wired network. Further still, in a peer-to-peer networking environment, transacting entity 114 may engage in one or more transactions with client device 104, which hosts an instance of client application 106, for implementation of one or more embodiments of transactional permissions.

Communication link 116 may refer to a communication link enabled by a protocol utilized to transmit data and/or information between client application 106, via client device 104, and service provider 108.

Communication link 118 may refer to a communication link enabled by a protocol utilized to transmit data and/or information, including rules 110 and/or real-time authorizations or denials, between authorizing entity 112 and service provider 108.

Communication link 120 may refer to a communication link enabled by a protocol utilized to transmit data and/or information pertaining to a transaction between client device 104 and transacting entity 114.

Communication link 122 may refer to a communication link enabled by a protocol utilized to transmit data and/or information, including one or more of rules 110, between service provider 108 and transacting entity 114.

Communication link 124 may refer to a communication link enabled by a protocol utilized to transmit data and/or information, including one or more of rules 110 and/or real-time authorizations or denials, between authorizing entity 112 and client device 104.

Communication link 126 may refer to a communication link enabled by a protocol utilized to transmit data and/or information pertaining to a transaction between transacting entity 114 and authorizing entity 112.

The aforementioned protocols referring to communication links 116, 118, 120, 122, 124, and 126 may include any mobile communications technology, e.g., GSM, CDMA, etc., depending upon the technologies supported by particular wireless service providers to whose services client device 104, service provider 108, authorizing entity 112, and/or transacting entity 114 may be assigned or subscribed. Further, one or more of the aforementioned communication links 116, 118, 120, 122, and 124 may be implemented utilizing non-cellular technologies such as conventional analog AM or FM radio, Wi-Fi™, wireless local area network (WLAN or IEEE 802.11), WiMAX™ (Worldwide Interoperability for Microwave Access), Bluetooth™, hard-wired connections, e.g., cable, phone lines, and other analog and digital wireless voice and data transmission technologies.

Thus, FIG. 1 shows an example implementation of a system configuration for implementing transactional permissions.

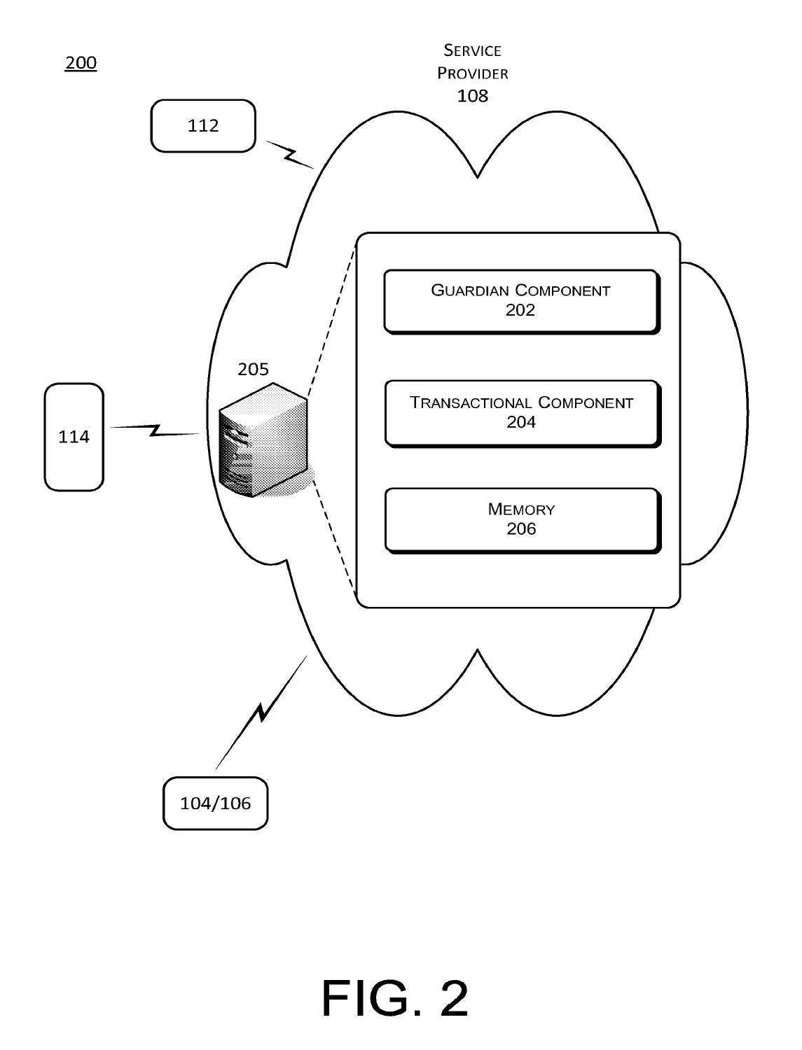

FIG. 2 shows an example configuration 200 of a service provider platform by which at least portions of transactional permissions may be implemented, arranged in accordance with at least some embodiments described herein. As depicted, example configuration 200 of service provider platform 108, hosted on a server 205, includes a guardian component 202, a transactional component 204, and a memory 206. In FIG. 2, service provider platform 108 hosted on server 205 is depicted relative to client application 106 hosted on client device 104, authorizing entity 112, and transacting entity 114, as in FIG. 1; however, this configuration is an example only, and is not intended to be limiting in any manner.

Service provider 108, as described with reference to FIG. 1, may be regarded as a cloud-based service and storage platform owned and/or operated by a third-party service provider. Service provider 108 may include a framework of hardware, software, firmware, or any combination thereof, through or to which digital data and information may be stored, passed, or shared with regard to a transaction for which at least one subscriber to the hosted service, including client device 104, is a party. More particularly, cloud-based platform 108 may be implemented as a web-based storage and sharing service to which client device 104, authorizing entity 112, and/or transacting entity 114 register prior to use. Service provider 108 may receive, from authorizing entity 112, rules 110 to appropriately authorize or deny a transaction involving client device 104 in the possession of or under the control of user 102.

Guardian component 202 may refer to a component of service provider 108 that is configured, designed, and/or programmed to receive, and enforce, rules 110 and/or real-time authorizations or denials from authorizing entity 112. In other words, guardian component 202 may receive settings or conditions upon which a potential or ongoing transaction for user (deferring entity) 102 having possession or control over client device 104 may be authorized or denied.

Guardian component 202 may be configured, designed, and/or programmed as a software module that resides, at least in part, on memory 206 and which may be executed by one or more processors on server 305.

Transactional component 204 may refer to a component of service provider 108 that is configured, designed, and/or programmed to receive one or more requests for authorization for a transaction involving device client 104, and to further transmit a determination regarding the requested authorization back to the requesting entity, which may be one or more of transacting entity 114 and client device 104. The determination regarding the requested authorization may be made and provided to transactional component 204 by guardian component 202 at the outset of the transaction or at a predefined milestone during the transaction. Non-limiting examples of such a predefined milestone may include a predetermined currency amount for a purchase, a predetermined time limit for a telephone call or for internet browsing, a purchase for multiple items that have been pre-authorized but further includes one or more particular items that have been predetermined to warrant authorization, etc.

Transactional component 204 may be configured, designed, and/or programmed as a software module that resides, at least in part, on memory 206 and which may be executed by one or more processors on server 305.

Memory 206 may refer to a storage or database hosted on server 205. Memory 206 may be configured, designed, and/or programmed to store one or more of rules 110 received from authorizing entity 112. Alternatively, rules 110 may be default rules that are pre-configured, without input from authorizing entity 112, and pre-stored on the memory of server 205. Further, in at least one alternative embodiment, one or more of rules 110 received at cloud-based platform 108 may be relayed directly to client device 104 for localized enforcement of the one or more of rules 110 by client application 106 on client device 104.

Thus, FIG. 2 show an example configuration of service provider 108 by which one or more embodiments of transactional permissions may be implemented.

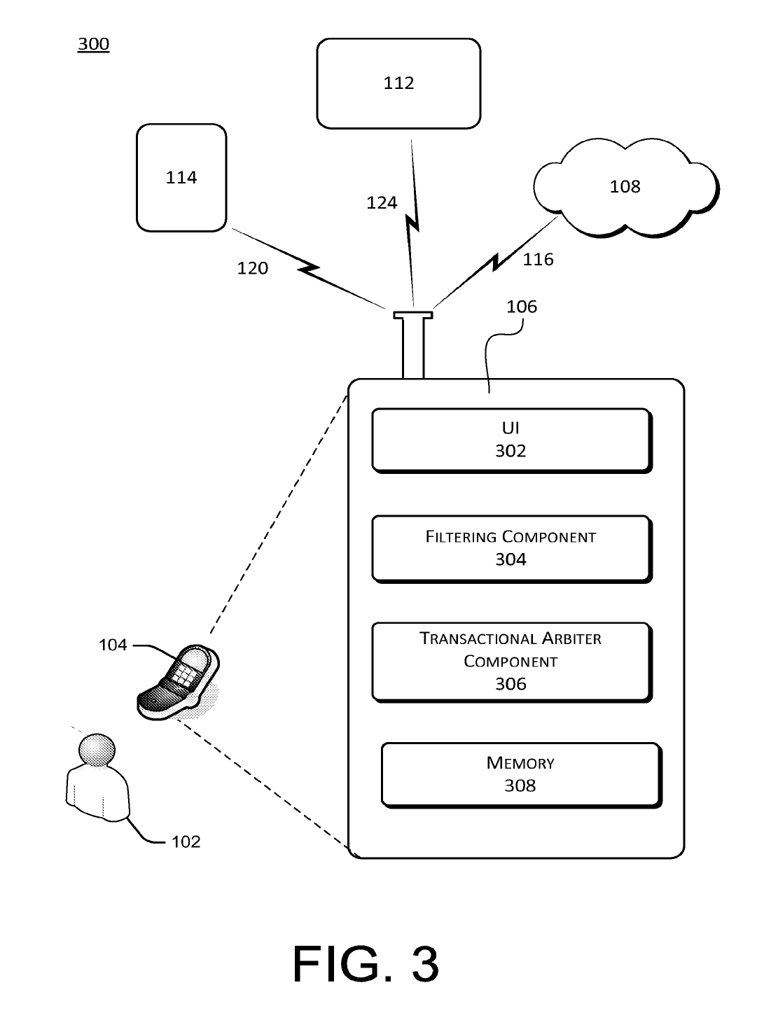

FIG. 3 shows an example configuration 300 of client application 106 by which at least portions of transactional permissions may be implemented, arranged in accordance with at least some embodiments described herein. As depicted, an example configuration of client application 106, hosted on client device 104, includes a user interface (UI) 302, a filtering component 304, a transactional arbiter component 306, and a memory 308. In FIG. 3, client device 104 is depicted relative to service provider platform 108, authorizing entity 112, and transacting entity 114, as in FIG. 1, along with the respective communication links relative to client device 104; however, this configuration is an example only, and is not intended to be limiting in any manner. At least some embodiments of transactional permissions may contemplate client application 106 representing a web browser that is configured to facilitate user interaction with at least service provider 108, transacting entity 114, and/or authorizing entity 112.

Some embodiments of transactional permissions may further include an instance of client application 106, or modified version thereof, hosted on a device corresponding to authorizing entity 112. Thus, whereas the present description of client application 106 makes reference to client device 104, on which client application 106 may be hosted, it is to be understood that the corresponding embodiment may be similarly applicable to authorizing entity 112, on which another instance of client application 106 or modified version thereof may be hosted. Differences between such embodiments are referenced herein.

User interface (UI) 302 may refer to a graphical component of client application 106. Alternatively, UI 302 may refer to a graphical component that is configured to enable interaction, via a web browser, with one or more or service provider 108, authorizing entity 112, or even transacting entity 114. Regardless, UI 302 may further enable user interaction with one or both of service provider 108 and authorizing entity 112. Further, when rules 110 are stored locally on either of client device 106 or authorizing entity 112, UI 302 may enable user interaction with rules 110. Further still, UI 302 may be configured, designed, and/or programmed to enable interactive participation by client device 104 with transacting entity 114 to conduct a commercial transaction.

UI 302 may be configured, designed, and/or programmed as a software module that resides, at least in part, on memory 308 or authorizing entity 112 and which may be executed by one or more processors on client device 104 or authorizing entity 112.

Filtering component 304 may refer to a component of client application 106 that interacts and interfaces with memory 308 or with authorizing entity 112, depending on which device a current instance of client application 106 is hosted, in order to enforce rules 110 as they may apply to a particular transaction. Accordingly, filtering component 304 may be configured, designed, and/or programmed as a software module that resides, at least in part, on memory 306 on client device 104 or memory 206 on authorizing entity 112, and which may be executed by one or more processors on the particular device. Filtering component 304 may be configured, designed, and/or programmed to filter through at least portions of rules 110 that have been received from service provider 108 or, for client application 106 hosted on client device 104 in a peer-to-peer networking environment, the portions of rules 110 may be received directly from authorizing entity 112.

Thus, at the outset of a transaction or at a predefined milestone during the transaction, filtering component 304 may compare contextual information pertaining to the transaction against one or more of rules 110 that have been received by, or are stored on, client device 104 to determine whether the transaction may be authorized, may be denied, or may require a real-time consultation with authorizing entity 112 due to peculiar circumstances involved in the transaction.

Transactional arbiter component 306 may refer to a component of client application 106 that is configured, designed, and/or programmed to request rules 110 that may apply to the particular transaction involving client device 104. In other words, in response to receiving a request for authorization of a transaction, transactional arbiter component 306 may retrieve at least portions of rules 110 from memory 306 or may otherwise receive, in real-time, conditions upon which the transaction for client device 104 may be authorized or denied.

Transactional arbiter component 306 may be configured, designed, and/or programmed as a software module that resides, at least in part, on memory 308 of client device 104 or memory 206 of authorizing entity 112 and which may be executed by one or more processors on client device 104 or authorizing entity 112.

Memory 306 may refer to a storage or database hosted on client device 104. On client device 104, memory 306 may be configured, designed, and/or programmed to store one or more of rules 110 received from authorizing entity 112. Rules 110 may be received from authorizing entityl12 via service provider 108. Alternatively, rules 110 may be directly from authorizing entity 112 for localized enforcement by filtering component 202.

Thus, FIG. 3 shows an example configuration 300 by which one or more embodiments of transactional permissions may be implemented.

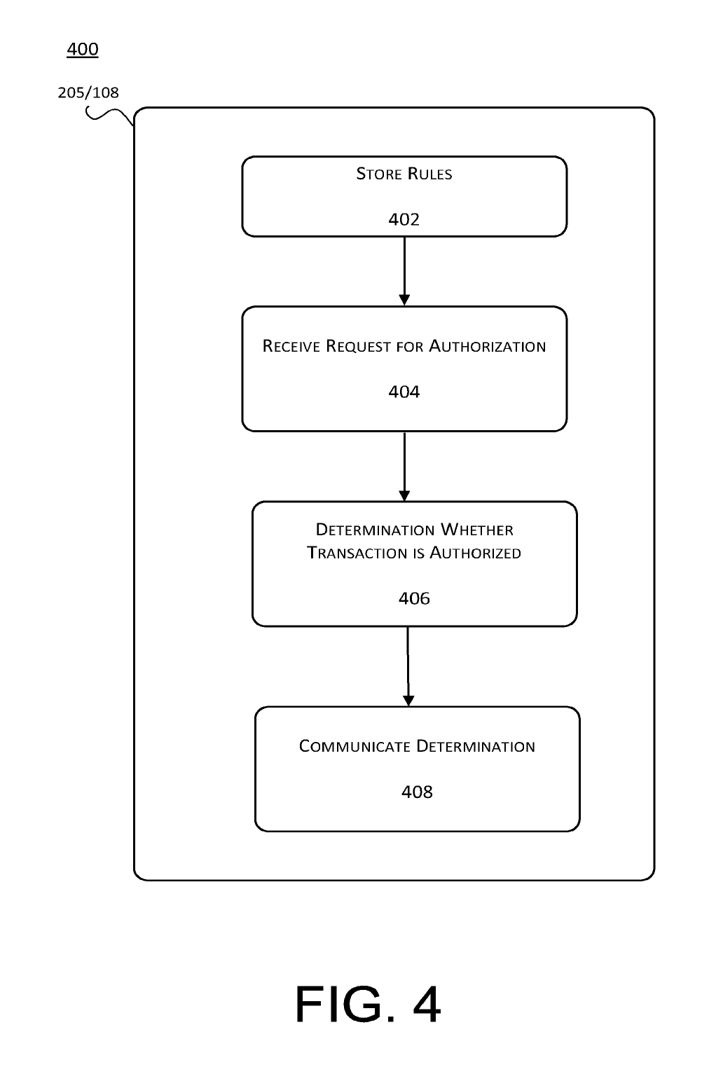

FIG. 4 shows an example processing flow 400 of operations for transactional permissions implemented by a service provider platform, in accordance with at least some embodiments described herein. As depicted, processing flow 400 includes sub-processes executed by various components that are part of service provider platform 108 hosted on server 205. However, processing flow 400 is not limited to such components, as obvious modifications may be made by re-ordering two or more of the sub-processes described here, eliminating at least one of the sub-processes, adding further sub-processes, substituting components, or even having various components assuming sub-processing roles accorded to other components in the following description. Processing flow 400 may include various operations, functions, or actions as illustrated by one or more of blocks 402, 404, 406, and/or 408. Processing may begin at block 402.

Block 402 (Store Rules) may refer to guardian component 202 receiving rules 110 from authorizing entity 112, via communication link 118. Rules 110 may include logic implemented by hardware, software, firmware, or any combination thereof, to appropriately authorize or deny a transaction involving client device 104, which may or may not be in the possession of or under the control of user 102. Thus, rules 110 may include rules and conditions under which transactions and classes of transactions may be authorized, may be denied, or may be subject to real-time authorization due to peculiar circumstances, for transactions involving client device 104. Processing may continue from block 402 to block 404.

Block 404 (Receive Request for Authorization) may refer to transactional component 204 receiving one or more requests for authorization for a transaction involving device client 104, via communication link 122 or communication link 116. The received one or more requests for authorization may include contextual information pertaining to the transaction including, but not limited to, a desired payment method; a desired transaction currency amount; the date and/or time of the transaction; the location of transaction including geography, store location, website, etc.; the subject matter of transaction; an elapsed time since the beginning of the transaction, e.g., for telephone calls or internet browsing; etc. Processing may continue from block 404 to block 406.

Block 406 (Determination Whether Transaction is Authorized) may refer to guardian component 202 accessing rules 110 that are stored in memory 206 for comparison against the contextual information included in the one or more requests for authorization. Accordingly, guardian component 202 may determine whether a particular one of the one or more requests for authorization may be authorized, may be denied, or may be subject to a further real-time consultation with authorizing entity 112 due to peculiar circumstances. Processing may continue from block 406 to block 408.

Block 408 (Communicate Determination) may refer to transactional component 204 transmitting a determination regarding the requested authorization back to the entity that submitted the one or more requests for authorization. Such entity may be one or both of transacting entity 114 and client device 104. Thus, the transmission of the determination may be executed via communication link 122 or communication link 116, respectively. Subsequently, the determination may result in the transaction being approved or denied.

Alternatively, in the event of a discovery of the aforementioned peculiar circumstances with regard to the transaction, the determination may result in transacting either or both of entity 114 and client device 104 contacting authorizing entity 112 for a further real-time consultation to a request an appeal of the determination, which is likely, at least, a tentative denial of the transaction. The results of the further real-time consultation may be transmitted from authorizing entity 112 to service provider 108 for relaying to client device 104 and transaction entity 114; or the results of the further real-time consultation may be made directly to either or both of client device 104 and transacting entity 114, via communication links 124 and 126, respectively.

Thus, FIG. 4 shows an example processing flow executed by service provider 108, hosted on server 205 for implementing transactional permissions.

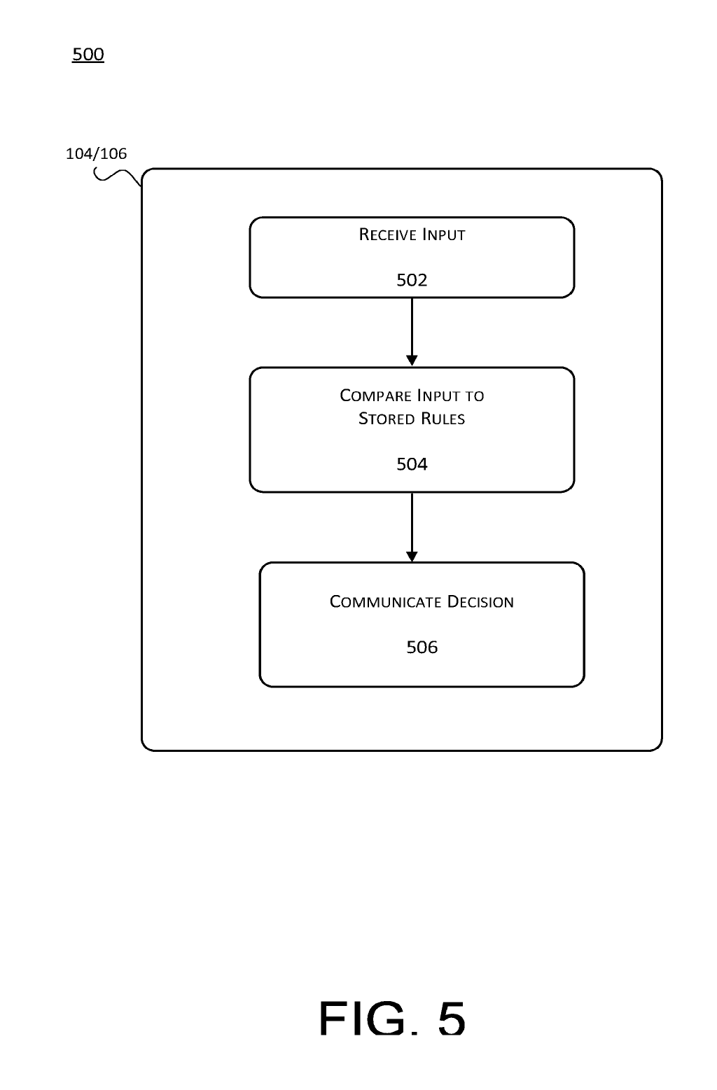

FIG. 5 shows an example configuration of a processing flow 500 of operations for transactional permissions implemented by a client application, in accordance with at least some embodiments described herein. As depicted, processing flow 500 includes sub-processes executed by various components that are part of client application 106 hosted on client device 104. However, processing flow 500 is not limited to such components, as obvious modifications may be made by re-ordering two or more of the sub-processes described here, eliminating at least one of the sub-processes, adding further sub-processes, substituting components, or even having various components assuming sub-processing roles accorded to other components in the following description. Processing flow 500 may include various operations, functions, or actions as illustrated by one or more of blocks 502, 504, and/or 506. Processing may begin at block 502.

Block 502 (Receive Input) may refer to transactional arbiter component 306 requesting one or more of rules 110 from service provider 108 pertaining to a transaction, either at the outset or at a predefined milestone of the transaction with transacting entity 114. The request may be facilitated by communication link 116. As set forth above, non-limiting examples of such a predefined milestone may include a predetermined currency amount for a purchase, a predetermined time limit for a telephone call or for internet browsing, a purchase for multiple items that have been pre-authorized but further includes one or more particular items that have been predetermined to warrant authorization, etc. Thus, prior to the request, transactional arbiter component 306 may transmit a request for transactional authorization to service provider 108.

Alternatively, in a peer-to-peer networking environment, transactional arbiter component 306 may transmit the request for authorization directly to authorizing entity 112. The alternative implementation of the request may be facilitated by communication link 124. Processing may proceed from block 502 to block 504.

Block 504 (Compare Input to Stored Rules) may refer to filtering component 304 filtering through at least portions of rules 110 that have been received from service provider 108, or directly from authorizing entity 112, and stored locally on memory 308. Filtering component 304 may thus compare the contextual information pertaining to the transaction against one or more of rules 110 that have been received by, or are stored on, client device 104 to determine whether the transaction may be authorized, may be denied, or may require a further real-time consultation with authorizing entity 112 due to peculiar circumstances involved in the transaction. Processing may continue from block 504 to block 506.

Block 506 (Communicate Decision) may refer to transactional arbiter 306 transmitting a determination regarding the requested authorization back to transacting entity 114, via communication link 120. Subsequently, the determination may result in the transaction being approved or denied by transacting entity 114.

Alternatively, the determination may result in transacting entity 114 contacting authorizing entity 112 for a real-time consultation due to the aforementioned peculiar circumstances pertaining to the transaction or due to a request for an appeal communicated by client device 104. The results of the real-time consultation may be transmitted from authorizing entity 112 to service provider 108 for relaying to transacting entity 114 or directly back to client device 104 or to transacting entity 114. The transmission of the further real-time consultation may therefore be facilitated by communication link 118 or communication link 124, respectively.

Thus, FIG. 5 shows an example processing flow executed by client application 106 hosted on client device 104 for implementing transactional permissions.

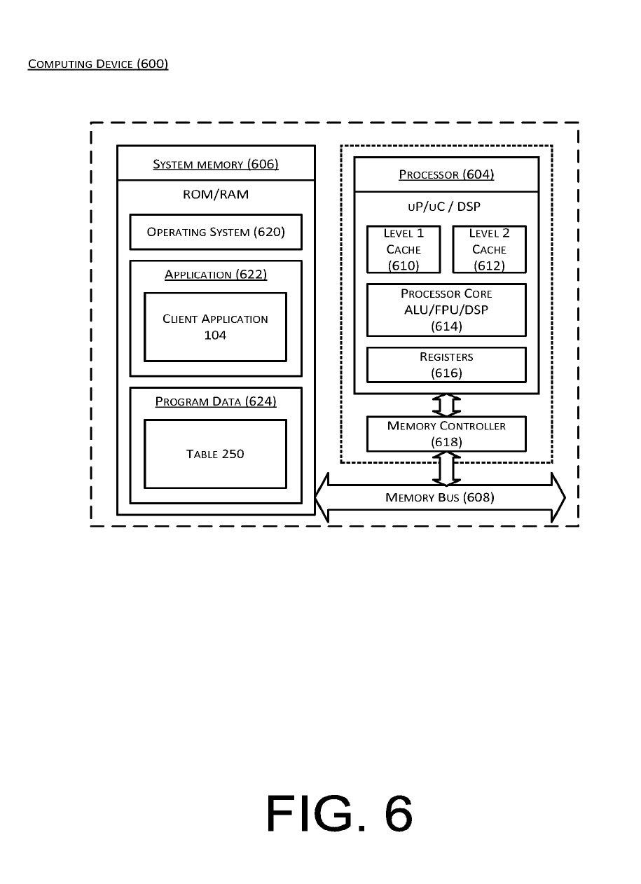

FIG. 6 shows a block diagram illustrating an example computing device 600 by which various example solutions described herein may be implemented, arranged in accordance with at least some embodiments described herein.

More particularly, FIG. 6 shows an illustrative computing embodiment, in which any of the processes and sub-processes described herein may be implemented as computer-readable instructions stored on a computer-readable medium. The computer-readable instructions may, for example, be executed by a processor of a device, as referenced herein, having a network element and/or any other device corresponding thereto, particularly as applicable to the applications and/or programs described above corresponding to the configuration 100 for transactional permissions.

In a very basic configuration, a computing device 600 may typically include one or more processors 604 and a system memory 606. A memory bus 608 may be used for communicating between processor 604 and system memory 606.

Depending on the desired configuration, processor 604 may be of any type including but not limited to a microprocessor (μP), a microcontroller (μC), a digital signal processor (DSP), or any combination thereof.

Depending on the desired configuration, system memory 606 may be of any type including but not limited to volatile memory (such as RAM), non-volatile memory (such as ROM, flash memory, etc.) or any combination thereof. System memory 606 may include an operating system 620, one or more applications 622, and program data 624.

Application 622 may be configured to transmit or receive identification information pertaining to client device 104 or authorizing entity 112 verify or validate such identifying data, and transmit device data as described previously with respect to FIGS. 1- 5. Program data 624 may include a table 650, which may be useful for implementing actuation of appropriate components or modules as described herein.

System memory 606 is an example of computer storage media. Computer storage media may include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein may be implemented, e.g., hardware, software, and/or firmware, and that the preferred vehicle may vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes for system configuration 100 via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers, e.g., as one or more programs running on one or more computer systems, as one or more programs running on one or more processors, e.g., as one or more programs running on one or more microprocessors, as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors, e.g., feedback for sensing position and/or velocity; control motors for moving and/or adjusting components and/or quantities. A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Lastly, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “ a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A computer-readable medium storing computer-executable components, comprising:
a guardian component configured to receive, from an authoritative entity, conditions upon which a potential transaction for a deferring entity may be authorized; and
a transactional component configured to:
receive, from a transacting entity, a request for authorization for an actual transaction with the deferring entity,
transmit, to the transacting entity, a determination as to whether the request for authorization for the actual transaction is acceptable when the stored conditions indicate that the actual transaction should be approved or denied,
transmit, to the transacting entity, a determination that more information is required for authorization for the actual transaction when the stored conditions do not indicate that the actual transaction should be approved or denied, and
transmit, to the authorizing entity, a request from the transacting entity for a real-time consultation to determine whether the actual transaction should be approved or denied when more information is required.

2. The computer-readable medium of claim 1, wherein the computer-executable components are executed in a hosted instance of an application.

3. The computer-readable medium of claim 1, wherein the computer-readable medium is hosted on a server.

4. The computer-readable medium of claim 1, wherein, upon receiving the request for authorization for the actual transaction, the transactional component is further configured to relay the request to a device controlled by the authoritative entity and to receive the determination from the authoritative entity.

5. The computer-readable medium of claim 1, wherein the potential transaction includes a credit or debit card transaction, and wherein the conditions upon which the potential transaction for the deferring entity may be authorized include a currency limit for the credit card transaction.

6. The computer-readable medium of claim 1, wherein the potential transaction includes a credit card transaction, and wherein the conditions upon which the potential transaction for the deferring entity may be authorized include an object of the credit card transaction.

7. The computer-readable medium of claim 1, wherein the potential transaction includes a telephone call, and wherein the conditions upon which the potential transaction for the deferring entity may be authorized include at least one of a time limit or a currency limit for the telephone call.

8. The computer-readable medium of claim 1, wherein the potential transaction includes at least one of internet browsing and real-time media access.

9. The computer-readable medium of claim 1, wherein the conditions upon which the potential transaction for the deferring entity may be authorized includes at least one restriction on location.

10. The computer-readable medium of claim 1, wherein the transacting entity is the deferring entity.

11. The computer-readable medium of claim 1, wherein the conditions include permissive emergency conditions for which the actual transaction may be automatically authorized.

12. A method, comprising:
storing, on a service provider server, restrictive conditions for a type of transaction for a deferring entity;
receiving, from a third party, a request for authorization for an actual transaction that has not been consummated;
determining, on the service provider server, whether the actual transaction may be consummated by comparing terms of the actual transaction, included in the request for authorization, with the restrictive conditions;
transmitting, to the third party, a response to the request for authorization as to whether the actual transaction may be consummated when a result of the determining indicates that the actual transaction should be approved or denied;
transmitting, to the third party, a response to the request for authorization indicating that more information is required for authorization for the actual transaction when the restrictive conditions do not indicate that the actual transaction should be approved or denied; and
receiving, from the third party, a request for a real-time consultation to determine whether the actual transaction should be approved or denied.

13. The method of claim 12, wherein the restrictive conditions include a decision algorithm.

14. The method of claim 12, wherein the service provider includes a credit card company.

15. The method of claim 12, wherein the service provider includes a mobile communication service provider.

16. A computer-readable medium storing computer-executable components, comprising:
a user interface configured to receive input pertaining to conditions of a pending transaction with a third party entity;
a filtering component configured to compare the input to stored rules by which a class of transactions including the pending transaction may be completed; and
a transactional arbiter component configured to authorize the pending transaction when the input compares favorably to the stored rules, to deny the pending transaction when the input compares unfavorably to the stored rules, and to perform a real-time consultation with an authoritative entity to determine whether the actual transaction should be approved or denied when the input indicates that more information is required for authorization for the actual transaction.

17. The computer-readable medium of claim 16, wherein the computer-readable medium is a smart card.

18. The computer-readable medium of claim 16, wherein the computer-executable components are run on a scanner that is communicatively connected to a server corresponding to the third-party entity.

19. The computer-readable medium of claim 16, wherein the computer-executable components are run in a hosted instance of an application on a mobile communication device.

20. The computer-readable medium of claim 16, wherein the computer-executable components are run in a hosted instance of an application on a mobile communication device, and wherein further the transactional arbiter component is further configured to at least temporarily shut down communicative access to the third party entity by the mobile communication device when the input compares unfavorably to the stored rules.

21. The computer-readable medium of claim 16, wherein the computer-executable components further comprise a communication module to submit the conditions of the pending transaction to an authorizing entity, bypassing execution by the filtering component and the transactional arbiter component.
